(19) United States
(12) Patent Application Publication
(10) Pub. No.: US 2006/0085138 A1
(43) Pub. Date: Apr. 20, 2006

(54) Identification and assignment of functionally corresponding regulatory sequences for orthologous loci in eukaryotic genomes

(75) Inventor: Andreas Klingenhoff, Muenchen (DE)

Correspondence Address: ROTHWELL, FIGG, ERNST & MANBECK, P.C., 1425 K STREET, N.W., SUITE 800, WASHINGTON, DC, 20005, US

(73) Assignee: Genomatix Software GmbH, Muenchen (DE)

(21) Appl. No.: 10/964,812

(22) Filed: Oct. 15, 2004

(51) Int. Cl. G06F 19/00

(52) U.S. Cl. 702/20

(57) ABSTRACT

The present invention relates to a method and computer program product for identifying a regulatory sequence of a coding sequence within the genome of a eukaroytc organism.

The present invention relates to a method and computer program product for identifying and/or defining the regulatory sequence of a transcript within the genome of a eukaroytic organism and/or for identifying groups of functionally corresponding regulatory sequences of orthologous transcripts in different eukaryotic organisms.

### BACKGROUND OF THE INVENTION

Today genomic sequence data from an increasing number of different organisms becomes available (Waterston et al., 2002; Lander et al., 2001). The quality of the data varies from short sequence fragments of several thousand base pairs from WGS (whole genome shotgun) projects to contiguous assembled sequences of whole chromosomes.

The annotation of the genomic sequences (e.g. location of genes, promoters, genomic repeats etc.) covers a similar broad range of quality and quantity. In a first step genomic sequences are usually analyzed by in silico methods to predict exon/intron structures (gene predictor) and repetitive sequence patterns. Short expressed sequences (EST) are then used to build supporting evidence for those gene predictions.

However, gene predictors are afflicted with high uncertainty—especially in case of gene start predictions. In addition, ESTs are usually only a few hundred base pairs in length and do not cover the 5′ end of a transcript. Consequently, the correct prediction of the gene start is still a crucial challenge today.

Since promoters are defined as the sequences upstream of a transcriptional start site (TSS) their annotation depends crucially on the correct annotation of the corresponding gene start.

The only way for high quality annotation of gene starts is via 5′ full-length cDNAS (Suzuki et al., 2001). Full-length cDNAs not only cover the coding sequence (CDS) but also contain the untranslated regions (UTR) located 5′ and 3′ of the CDS. Ideally they start with a real transcriptional start side (TSS) and end at the polyA tail. Only mapping of these full-length cDNAs to the genomic sequence results in a reliable annotation of existing transcripts for a gene locus. Therefore it is the only way to annotate promoter regions precisely. However, so far only for a few genome projects limited collections of full-length cDNAs are available (Ota et al., 2004; Imanishi et al., 2004; Okazaki et al., 2002).

One way to overcome the significant problems in the quality of 5′ complete is gene annotation is comparison of annotations available for orthologous loci (i.e. from different organisms). Unfortunately the divergence of the genomic sequences of even closely related organisms (e.g. rat and mouse) does not allow a genome wide mapping of full-length cDNAs from one organism to the genome of the other. Especially the non-coding UTRs of the cDNAs are only sparsely conserved between the organisms. Lowering the similarity thresholds for the mapping of these sequence regions often results in ambiguous results for the leading exon of a transcript. Accordingly, the results cannot be used for the precise annotation of promoter regions.

Simply scanning windows of sequences as a mode of length restriction does not work. The restriction by cross-species exon mapping is not obvious even to experts in the field and on top of that requires application of the precise rules outlined above to yield quality results. Due to short exon length and relatively low sequence conservation the transfer of evidence between species is also not trivial.

The approach described here allows to evaluate existing annotation and to transfer high quality annotation from one organism to another where this information is incomplete or missing.

### SUMMARY OF THE INVENTION

The invention relates to a method for identifying functionally corresponding regulatory sequences of orthologous transcripts within the genome of eukaroytic organisms comprising:
(a) mapping the sequences of a plurality of orthologous transcripts within the genomes of eukaryotic organisms,
(b) identifying at least one sequence which is conserved between the orthologous transcripts of (a),
(c) defining a target region for a conserved sequence in the genome of the respective eukaryotic organism based on the location of a conserved sequence identified in step (b),
(d) identifying and/or defining a regulatory sequence within the target region, and
(e) optionally assigning the regulatory sequences to groups of functionally corresponding regulatory sequences.

Further, the invention relates to a computer program product for identifying functionally corresponding regulatory sequences within the genome of eukaryotic organisms comprising:
(a) means for mapping the sequences of a plurality of orthologous transcripts within the genomes of a plurality of eukaroytic organisms,
(b) means for identifying at least one sequence which is conserved between the orthologous transcripts of (a),
(c) means for defining a target region for a conserved sequence in the genome of the respective eukaryotic organism based on the location of a conserved sequence identified by means (b),
(d) means for identifying and/or defining a regulatory sequence within the target region, and
(e) optionally means for assigning the regulatory sequences to groups of functionally corresponding regulatory sequences.

The present invention allows the identification of groups of functionally corresponding regulatory sequences of orthologous transcripts within the genome of eukaryotic organisms. Further, the present invention allows the identification of previously unknown regulatory sequences for transcripts.

### DETAILED DESCRIPTION OF THE PREFERRED EMBODIMENTS

General Principle

The present method and computer program product compares and analyses the transcripts annotated for a set of orthologous loci from a group of eukaryotic organisms. Functionally corresponding regulatory sequences, which are preferably located 5′ to the transcript are identified and/or characterized and assigned into groups. The regulatory sequences are preferably selected from promoters, enhancers and/or repressor regions; more preferably promoter regions. The transcripts may comprise protein coding sequences. The transcripts, however, may be or comprise functional RNA molecules.

The identification of functionally corresponding regulatory sequences is achieved by checking the orthologous transcripts for a conserved exon/intron structure. If the annotation in any of the orthologous loci is 5′-incomplete, this can now be extended by a potential conserved promoter region (termed CompGen promoter). This is carried out by mapping an exon, preferably the first exon of a transcript from one organism to the corresponding orthologous genomic sequence of the target organism.

For this purpose, the potential target region in the genomic sequence is restricted to a predetermined length of e.g. several thousand base pairs by the prior analysis of the exon/intron structure of the transcript used for the mapping. Due to this restriction of the target region it is now possible to lower the similarity thresholds to a level that is required for cross species mapping of less conserved UTRs without obtaining ambiguous results.

Generation of Homology Groups with Orthologous Loci

In a first step, orthologous loci are identified by an exhaustive pairwise comparison of mRNA sequences available for the selected organisms. The orthologous loci are defined by matching transcripts from two or more eukaryotic organisms. e.g. a transcript from one or several organisms for which the regulatory region shall be identified and transcripts from one or several second organisms for which the regulatory region is known. Preferably, two loci are marked as orthologous if the related transcripts are pairwise best matches. A potential source for this data is the HomoloGene database provided by the National Center for Biotechnology Information (NCBI).

Based on these pairwise relations the loci are assigned to closed groups (homology groups). Two loci are connected in a homology group if they are both assigned to a common third locus but are not necessarily connected by a direct relationship. Each locus can only be member of one homology group.

The eukaroytic organisms analyzed preferably belong to the same kingdom of eukaryotic organisms, e.g. animals, plants or fungi. More preferably, the eukaryotic organisms belong to the same order, e.g. they are mammals, birds, reptils, fish, insects, etc. In general, a close relationship between the first and the second organism is preferred.

Analyzing Transcripts of the Loci in a Homology Group

All available exon/intron-annotation for alternative transcripts for the loci in a homology group is collected from the genome annotation. Alternative transcripts differ in their exon/intron structure but may also start from different transcriptional start sites and consequently have different regulatory regions, e.g. promoter regions. Preferably, the exons of all transcripts are analyzed for conservation, i.e. the presence of conserved sequences. Two exons are considered conserved if they have an identical length, and show a sufficient sequence similarity (<10% gaps). The sequence similarity is preferably determined using a Smith-Waterman alignment (Smith & Waterman, 1981). Preferably, the most 5′ located conserved exons are used to arrange the transcripts from different loci (i.e. from different organisms) on a common scale. They represent the anchor for further distance calculations. It is noted that these exons are not necessarily the first exons, which is a major difference to 5′-complete EST assembly algorithms.

Vertical Transfer of Annotation Between the Loci in a Homology Group

The first exon of each annotated transcript is mapped to the genomic sequences of all other orthologous loci (targets) in the homology group. Preferably, this is done exhaustively for all of the loci.

The mapping is preferably carried out by aligning the exon sequence and the genomic sequence (Needleman & Wunsch, 1970). To allow high quality mapping across species the potential target region for mapping is restricted. The distance between the anchor point and the transcriptional start site (TSS) of a source transcript, i.e. a transcript for which at least the TSS and preferably the regulatory region to be identified is known, is used to determine a potential location, i.e. a target or mapping region for the alignment on the genomic target sequence which is extended by preferably about 20,000 bp and more preferably up to about 10,000 bp upstream and downstream to cover the variability of the exon/intron structure of different loci. In the case of extremely large distances between the anchor point and the first exon of the source transcript (>100,000 bp) the length of the target or mapping region of the genomic sequence is extended relatively to that distance (preferably up to about 20% of the distance).

For each mapping that fulfills at least one of the following criteria a pseudo transcript consisting of a single exon is generated for the target locus.
(i) The alignment preferably contains ≧70% identical nucleotides, ≦20% gaps and has ≧20 bp in length.
(ii) The score calculated for the alignment normalized by the length of the alignment preferably exceeds a value of 2.

The extension and the position of the exon are derived from the mapping results. Thus the annotation for a locus is temporarily extended by conserved first exons from orthologous loci indicating a potential conserved regulatory, e.g. promoter region.

Identification of Corresponding Regulatory Regions

In the next step the sequences of all first exons from the different loci in a homology group are aligned against each other. These first exons may now be derived either from the genome annotation or from the pseudo transcripts generated by the mapping process described above. Suitable alignments are selected by the following criteria:
(i) The alignment contains ≧70% identical nucleotides, ≦20% gaps and has ≧50 bp in length.
(ii) The alignment contains ≧60% identical nucleotides, ≦5% gaps and has ≧50 bp in length.
(iii) The alignment contains ≦5% gaps and the score calculated for the alignment exceeds a value of 300.
(iv) The alignment has a length of ≧60 bp and the score calculated for the alignment normalized by the length of the alignment has a value of at least 2.
   For transcripts starting with a first exon shorter than 60 bp two additional criteria are used.
(v) The alignment contains ≧90% identical nucleotides, ≦20% gaps and has ≧20 bp in length.
(vii) The alignment contains ≧75% identical nucleotides, ≦10% gaps and has ≧20 bp in length.

For each alignment that fulfills at least one of the criteria the two corresponding transcripts are assigned as pair-wise corresponding partners. The list of pair-wise assignments is then used to build closed groups of related transcripts.

For those groups that contain more than one transcript for a locus a regulatory region, e.g. a promoter region may be calculated that covers all of the potential sites, e.g. transcriptional start sites reflecting the known variability of transcriptional initiation processes (Suzuki et al., 2001). For loci where only a pseudo transcript is assigned to a group of related transcripts a new potential promoter region (CompGen promoter) supported by annotation from orthologous loci is added to the annotation. There is no transcript assigned to these promoters, as the detailed exon/intron structure is not determined by the present method.

The regulatory regions, e.g. promoter regions may then be assigned to a group or set comprising functionally corresponding regulatory regions, i.e. regulatory regions to which a common or at least similar biological function may be assigned.

It should be noted that several groups or sets of regulatory sequences may be assigned to a single locus, particularly if several pair-wise matching partners are identified for the sequence to be analyzed.

Further, the present invention shall be explained in more detail by the following Example.

### EXAMPLE

The present method was applied to the genomes of different groups of eukaryotic organisms. The first group contains the three vertebrates Homo sapiens, Mus musculus, and Rattus norvegicus. The second group comprises the genomes of the two insects Drosophila melanogaster and Anopheles gambiae.

| | homology groups | promoter sets | CompGen promoter |
|---|---|---|---|
| vertebrates | 17069 | 27253 | 26197 |
| insects | 496 | 239 | 136 |

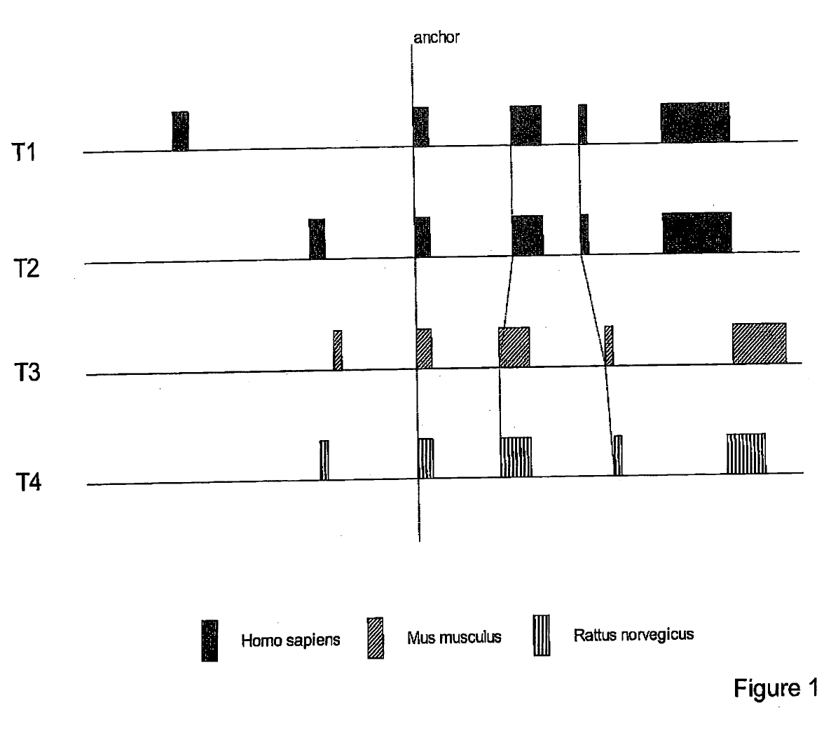

The example in FIG. 1 contains four transcripts (two alternative transcripts from H. sapiens (T1 and T2), one from M. musculus (T3), and one from R. norvegicus (T4)). The exons conserved between different loci are connected by dotted lines. Exon 2 is the most 5′ located conserved exon and is therefore selected as common anchor.

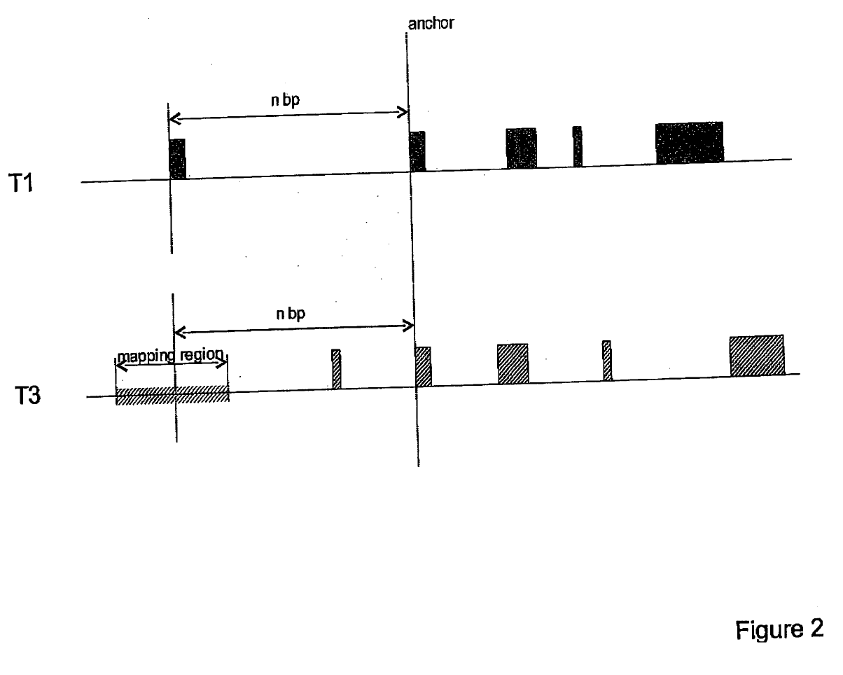

FIG. 2 shows the definition of a target (mapping) region in the genomic sequence of M. musculus (T3) based on the distance (nbp) between the anchor and the TSS in the genomic sequence of H. sapiens (T1).

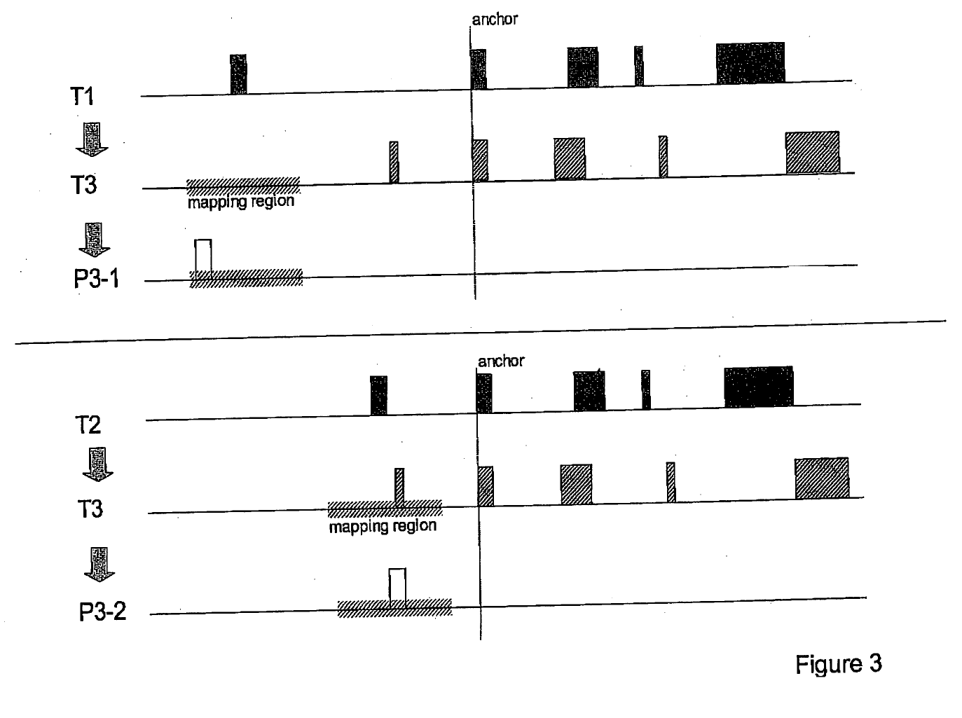

FIG. 3 shows the results for the mapping of transcript T1 and T2 (human) to the genomic sequence of the murine locus (T3). The exhaustive mapping of the transcripts included in FIG. 1 results in 8 pseudo transcripts (P1-3, P1-4 for H. sapiens, P3-1, P3-2, P3-4 for M. musculus and P4-1, P4-2, P4-3 for R. norvegicus).

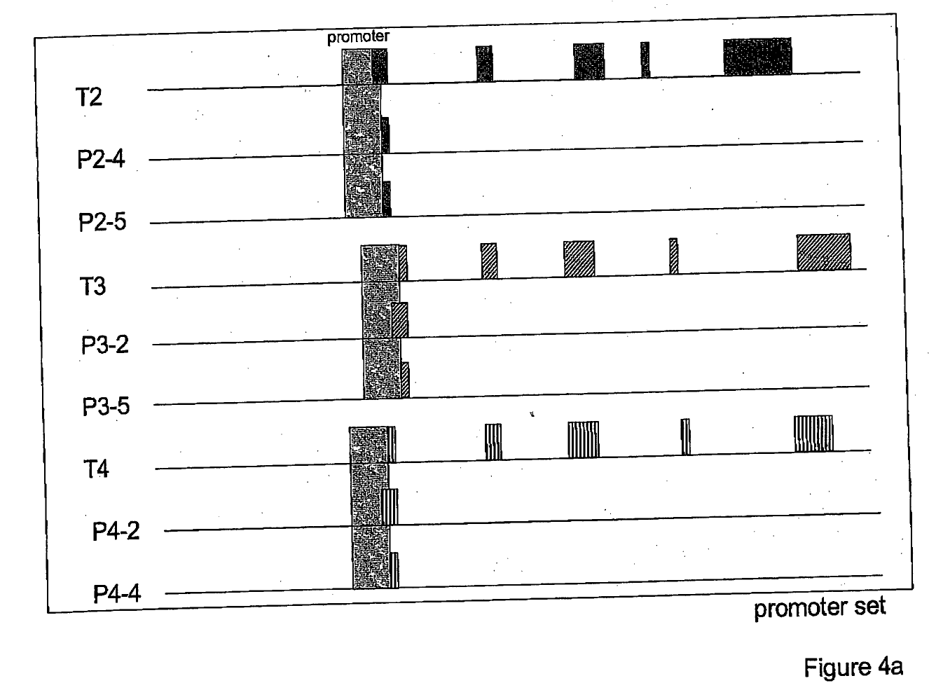

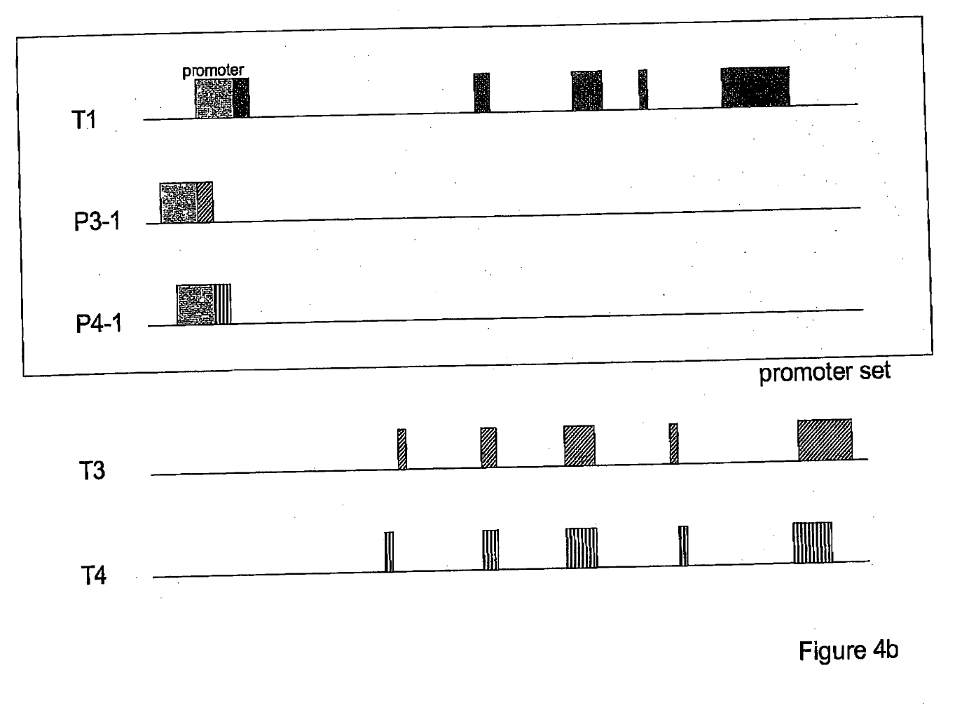

FIGS. 4a and 4b show the building of closed groups of transcripts based on the sequences T1, T2, T3 and T4. In FIG. 4a the calculation of promoter regions is shown for homology groups which contain more than one transcript (P2-4 and P2-5; P3-2 and P3-5; or P4-2 and P4-4) for a locus. In FIG. 4b the mapping of promoter regions is shown for which only a pseudotranscript has been assigned to a homology group of related transcripts.

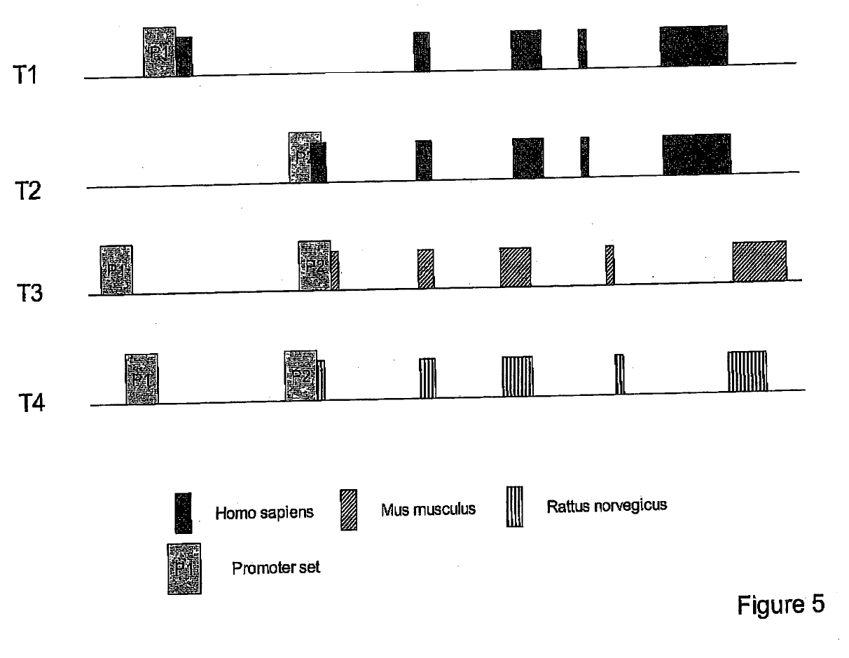

The promoter regions for M. musculus (T3) and R. norvegicus (T4) belonging to promoter set 1(P1) in FIG. 5 therefore are supported by the annotation available from the human genome (T1) and by the sequence similarity detected in the two target sequences.

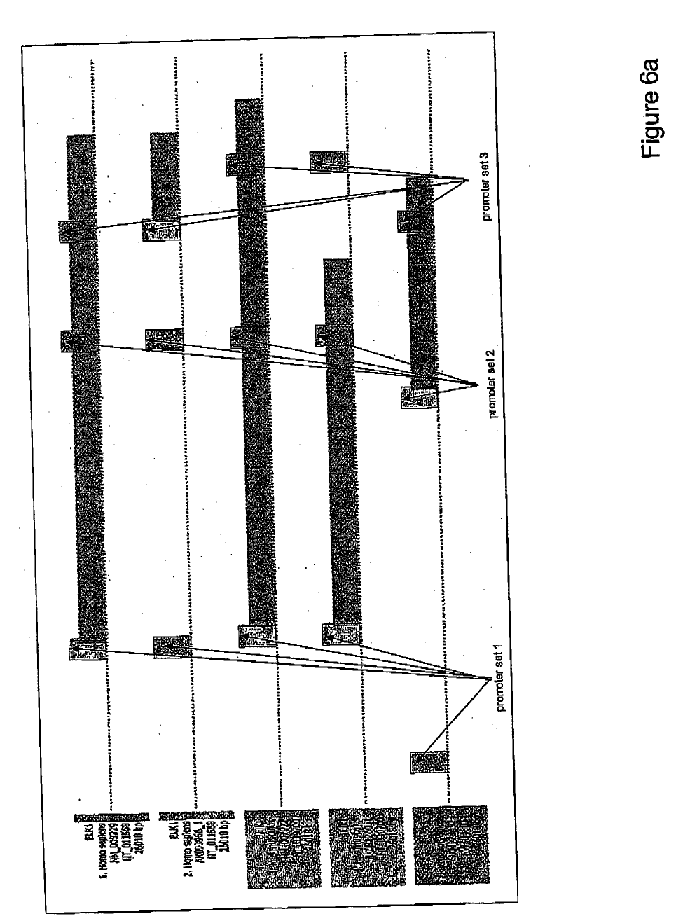

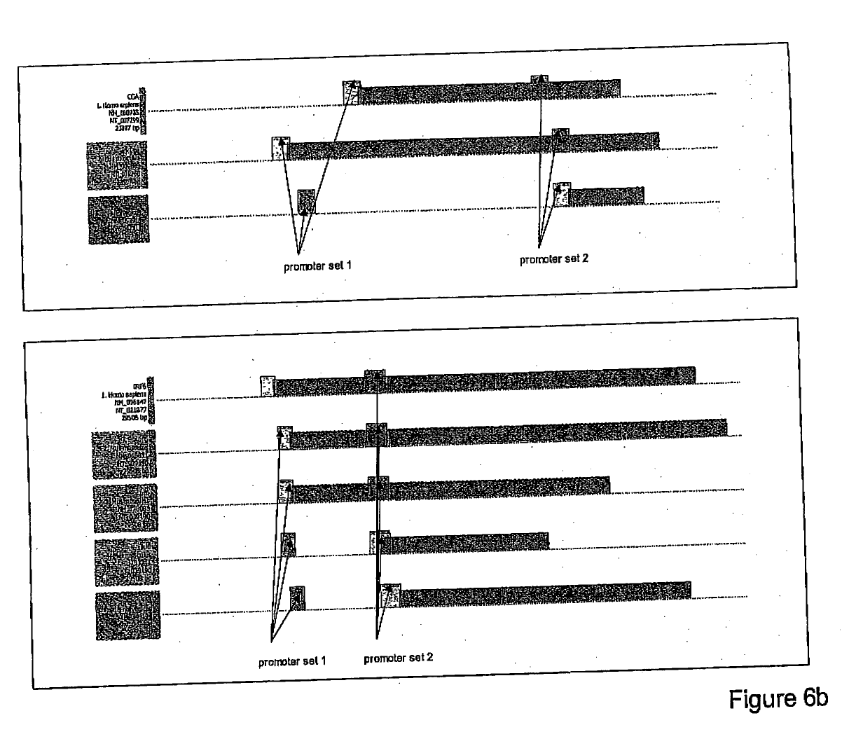

FIG. 6a shows a graphical representation of the results generated by the present method for the orthologous ELK1 transcripts from Homo sapiens, Mus musculus, and Rattus norvegicus. In this example the promoters for the first human transcript (1) and the two murine transcripts (3,4) are assigned to one group (promoter set one) because of the sequence similarity of the first exon of each of the transcripts. The promoter set also contains a promoter sequence from the rat genome for which no transcript is known so far. The location of this promoter sequence was determined by the mapping of the first exons of the corresponding transcripts from Homo sapiens (1) and Mus musculus (3,4). Promoter set 2 and 3 are both based on a single promoter sequence annotated in only one of the organisms (2,5). The first exon of the corresponding transcript can be mapped on the genomic sequence of the two remaining organisms and is used to determine the location of the corresponding promoter sequences. Each of these promoter sequences is located at the 5′ end of an exon annotated for the respective organism and therefore most probably represents a functional regulatory sequence.

FIG. 6b shows the results generated for the two homology groups CGA and IRF6. For the CGA gene one transcript for each of the organisms is available. The transcript annotated for the rat is obviously lacking a 5′ leading exon. The originally annotated promoter (assigned to promoter set 2) does not correspond to the promoters annotated for the two other organisms (assigned to promoter set 1). Due to the additional promoter annotation and the assignment into promoter sets functionally corresponding promoter regions, i.e. the members of promoter sets 1 and 2, respectively, from each of the organisms are available for further analysis.

The results obtained for the IRF6 locus are comparable. Only the promoter region annotated in the human genome is excluded from the promoter sets indicating either a low degree of conservation between the organisms or an error in the annotation.

### Refrences

Needleman S B, Wunsch C D.

A general method applicable to the search for similarities in the amino acid sequence of two proteins.

J Mol Biol. 1970 March;48(3):443-53.

Smith T F, Waterman M S.

Identification of common molecular subsequences.

J Mol Biol. 1981 Mar. 25;147(1):195-7.

Suzuki Y. et al

DBTSS: DataBase of human Transcriptional Start Sites and full-length cDNAs.

Nucleic Acids Res. 2002 Jan. 1;30(1):328-31.

Suzuki Y. et al.

Diverse transcriptional initiation revealed by fine, large-scale mapping of mRNA start sites.

EMBO Rep. 2001 May;2(5):388-93.

Waterston R H et al.

Mouse Genome Sequencing Consortium.

Initial sequencing and comparative analysis of the mouse genome.

Nature. 2002 Dec. 5;420(6915):520-62.

Okazaki Y. et al.

FANTOM Consortium; RIKEN Genome Exploration Research Group Phase I & II Team.

Analysis of the mouse transcriptome based on functional annotation of 60,770 full-length cDNAs.

Nature. 2002 Dec. 5;420(6915):563-73.

Lander E S, et al.

International Human Genome Sequencing Consortium.

Initial sequencing and analysis of the human genome.

Nature. 2001 Feb. 15;409(6822):860-921.

Imanishi T. et al.

Integrative Annotation of 21,037 Human Genes Validated by Full-Length cDNA Clones.

PLoS Biol. 2004 Apr. 20.

Ota T. et al.

Complete sequencing and characterization of 21,243 full-length human cDNAs.

Nat Genet. 2004 January;36(1):40-5.

1. A method for identifying functionally corresponding regulatory sequences of orthologous transcripts within the genome of eukaroytic organisms comprising:
(a) mapping the sequences of a plurality of orthologous transcripts within the genomes of eukaryotic organisms,
(b) identifying at least one sequence which is conserved between the orthologous transcripts of (a),
(c) defining a target region for a conserved sequence in the genome of the respective eukaryotic organism based on the location of a conserved sequence identified in step (b),
(d) identifying and/or defining a regulatory sequence within the mapping region, and
(e) optionally assigning the regulatory sequences to groups of functionally corresponding regulatory sequences.

2. The method of claim 1 wherein the regulatory sequence is selected from the group consisting of promoters, enhancers and repressors, and combinations thereof.

3. The method of claim 2 wherein the regulatory sequence is a promoter.

4. The method of claim 1 wherein the eukaryotic organisms belong to the same order.

5. The method of claim 4 wherein the organisms are mammals.

6. The method of claim 1 wherein the transcripts are marked as orthologous when they are pairwise best matches within the respective organisms.

7. The method of claim 1 wherein step (a) comprises generating a homology group containing a plurality of orthologous loci in the genome of the respective eukaryotic organisms.

8. The method of claim 7, wherein step (b) comprises analysing of transcript sequences from the orthologous loci of a homology group.

9. The method of claim 8 wherein step (b) comprises identifying conserved exons in the transcript sequences.

10. The method of claim 9 wherein two exons are identified as conserved when they have an identical length.

11. The method of claim 1 wherein step (c) comprises selecting a conserved sequence as an anchor for defining the target region.

12. The method of claim 11 wherein the most 5′ located conserved sequence is selected as an anchor.

13. The method of claim 11 wherein the location of the target region is defined by the distance between the anchor and the transcriptional start site of a source transcript.

14. The method of claim 11 wherein the mapping region in the genome of the first organism has a length of up to about 20,000 bp.

15. The method of claim 11 wherein the mapping region in the genome of the first organism has a length of up to about 20% of the distance between the anchor and the transcriptional start site of the source transcript.

16. The method of claim 1 wherein step (d) comprises generating a pseudotranscript sequence for the target locus.

17. The method of claim 16 wherein the pseudotranscript is generated based on a mapping between the sequence in the target region and the sequence of the first exon of a source transcript, wherein the mapping has to fulfill at least one of the criteria:
(i) the alignment contains ≧70% identical nucleotides, ≦20% gaps and has ≧20 bp in length; and
(ii) the score calculated for the alignment normalized by the length of the alignment exceeds a value of 2.

18. The method of claim 8 wherein step (d) comprises aligning first exons from transcript or pseudotranscript sequences, assigning transcripts which fulfill predetermined alignment criteria as pair-wise matching partners, and calculating the location of regulatory regions.

19. The method of claim 18 wherein calculating is based on the locations of potential transcriptional start sites upstream the first exon sequences.

20. A computer program product for identifying functionally corresponding regulatory sequences within the genome of eukaryotic organisms comprising:
(a) means for mapping the sequences of a plurality of orthologous transcripts within the genomes of a plurality of eukaroytic organisms,
(b) means for identifying at least one sequence which is conserved between the orthologous transcripts of (a),
(c) means for defining a target region for a conserved sequence in the genome of the respective eukaryotic organism based on the location of a conserved sequence identified by means (b),
(d) means for identifying and/or defining a regulatory sequence within the target region, and
(e) optionally means for assigning the regulatory sequences to groups of functionally corresponding regulatory sequences.
